(19) United States
(12) Patent Application Publication
(10) Pub. No.: US 2004/0128265 A1
(43) Pub. Date: Jul. 1, 2004

(54) Return mechandise processing system

(76) Inventors: Lyn M. Holtz, Annandale, VA (US); Robert E Czerwinski, Reston, VA (US); Scott R Bombaugh, Burke, VA (US); William K Craft III, Troutville, VA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/474,003

(22) PCT Filed: Apr. 5, 2002
(86) PCT No.: PCT/US02/08240

(51) Int. Cl. G06F 17/60

(52) U.S. Cl. 705/406; 705/402

(57) ABSTRACT

The present invention is directed to an improved computer-implemented system for processing mail packages to be returned to a particular merchandise vendor. This system includes an image scanning device that scans one or more images of each package into a database. Once the images are stored in the database, an operator can perform information processing, such as “postage due” calculations, independent of the manual sorting of the packages themselves. This system also employs a processing workstation that allows an operator to process the electronic video of each package at a convenient time and place and at a remote location. This invention further allows for reports to be sent to the merchandise vendor at a convenient time and in an expedient manner. For example, reports can be sent via E-mail either before or after the packages themselves are actually delivered to the vendor.

### CROSS REFERENCE TO RELATED APPLICATION

This application claims the benefit of priority under 35 U.S.C. § 119 of U.S. Provisional Patent Application No. 60/281,782, filed Apr. 6, 2001, entitled “Return Merchandise Processing System,” the full contents of which are relied upon and incorporated herein.

### BACKGROUND OF THE INVENTION

A. Field of the Invention

The present invention relates to a method and system for video coding articles and, more particularly, to a return processing method and system for analyzing video images of a plurality of return merchandise packages.

B. Description of the Related Art

The growth of the Internet has brought about a profound effect on the purchase and delivery of merchandise in the global marketplace. For example, companies who have web sites on the Internet, such as the Home Shopping Network, have been able to expand their relevant sales market into ever-expanding markets. This expansion has, in turn, enabled more consumers to consider a broader range of commodities and enter into transactions more easily and efficiently, such as by simply visiting a company's web site via the Internet and requesting shipment of the selected merchandise.

To carry out such transactions, merchants typically rely upon postal delivery companies, such as the United States Postal Service, to deliver packaged merchandise directly to the consumer's home or workplace. Consumers usually inspect the merchandise for the very first time only after actual delivery. Upon inspection, if the consumer finds that the merchandise is not acceptable, the consumer's recourse is return of the merchandise itself along with a request for an appropriate refund.

As a result, postal delivery companies have experienced an increase in the volume of requests by consumers to return packaged goods back to the vendors in a prompt fashion. Attendantly, a need has arisen for postal companies to process and return the ever-increasing volume of these types of packages in more efficient ways.

FIG. 1 illustrates the steps required in a typical return processing operation. In this operation, workers must perform a number of complex, time consuming, and labor intensive actions in real time before packages can be delivered. For instance, typical return processing systems involve several package handling and postage calculation steps within a number of vendor production lines, each of which are devoted to processing packages for return delivery to a single vendor.

Generally, the mail delivery process begins when one or more delivery trucks deposit unsorted or “raw” mail, which includes various types of envelopes, packages, or other articles for delivery to different destinations, upon a processing site (step S10). The terms “packages” and “articles” are not limited to any particular dimension, configuration, or type of article, and may include any form of container, such as a box, parcel, bundle, packet, envelope, etc. As used herein, these terms are interpreted to encompass the same broad definition of all such delivery items. Upon arrival, workers manually perform a primary sortation step to identify packages that contain merchandise to be returned to a particular vendor and separate those return merchandise packages from non-return or “regular mail” packages (step S10). Workers then either send regular mail packages to a regular mail processing production line 14, or sort return merchandise packages based on which vendor they are to be returned to (step S12). Alternatively, mail may arrive in separate groups of return merchandise packages and regular mail packages, so as to obviate the need for such a primary sortation step. Upon receipt, workers then process the mailer specific packages by placing them upon the correct transport device, such as a conveyor, that corresponds to one of several vendor production lines 20A, 20B, 20C. By way of example, if a worker determines that a consumer has requested that a particular package be returned to Company “A,” then that package must be placed on the “Vendor A Manual Processing Production Line” 20A. After performing a number of arduous handling and postage calculation steps for each vendor's production line, workers must then generate postage expense reports, alternatively referred to as “manifests,” and deliver packages along with the expense reports to the vendors (steps S22A, S22B, S22C).

FIG. 2 illustrates a flow diagram of the prior art return processing system that occurs in a single vendor's production line. Soon after transport device 32 receives return merchandise packages, which have already been sorted by company (step S30), a worker examines each article to determine whether the consumer or the vendor has affixed a label requesting special delivery services to the package itself (step S34). The label may contain a bar code or any other indicia representing a particular type of special delivery service. Special delivery services may involve a delivery service known as “delivery confirmation,” which involves notifying the person requesting return delivery that the vendor has received the return merchandise package. However, special services may also include any other known type of delivery service, such as insured delivery, certified delivery, or return receipt.

If a label has been attached to the package, then a worker scans a bar code on the label into a database (step S35). This step is preferably accomplished by using any known data collection and tracking system, such as a Mobile Data Collection Device (“MDCD”), which is a type of hand-held device that scans bar codes on a package to collect information represented by the bar code and downloads that information into a database. Typical package processing and delivery systems employ MDCDs to monitor the location of each package throughout various stages of the article handling and delivery process. The information represented by the bar code of a label for a particular type of service is usually in the form of a specific number, alternatively referred to as the article or “package number.” Workers may use this article number to identify and track the particular type of special delivery service that has been requested for each package. Although most packages only have a single label affixed (i.e., hence only a single bar code or article number), if multiple labels are affixed to a single package, then that package will have multiple article numbers. As a result, workers must scan in all affixed labels and process each package based on the type of article number(s) represented by each label.

After a worker has either scanned the label into the MDCD database or determined that no label has been attached to the package, each package is then sorted by type and/or destination zip code (step S36). In sorting by type and destination zip code, the worker must closely observe each package. Sorting by type of package is used to classify packages that either require a particular type of handling service or do not require any special treatment at all. For example, if the consumer has already affixed sufficient postage to perform a requested special service and deliver the package to the correct location, then the package is classified as a “straight” package. Because straight packages do not require any postage due calculations, they are sent to a “No Postage Due Bin” 38 for immediate delivery in accordance with each package's destination zip code (step S58). Alternatively, packages may be classified according to which specific special delivery service (e.g., insured, certified, return receipt, delivery class, or delivery confirmation) has been requested. As another example, sorting of return packages may be based on destination zip code.

Upon identifying a package's type and/or destination zip code, a worker then sends the package to one of a plurality of bulk mail containers (“BMC”). 38, 40, 42, 44. Once packages are deposited in one of the BMCs, a worker must then perform a set of manual processing steps, as shown in FIG. 3. The worker typically performs at least seven tasks before calculating the total postage balance due to be paid (step S70). These tasks involve weighing each package, as well as determining the package's origin zip code, destination zip code, and delivery class. Moreover, the worker may also determine whether a merchandise return label is affixed, and record the amount of postage already affixed (if any). In addition, the worker may also have to scan one or more bar codes of the package into the data collection and tracking system described above. After performing these tasks, the worker calculates the postage due for each package based on, among other things, the weight, the origin, and the destination of the package, for example (step S72). The worker may then remove the merchandise return receipt if necessary (step S74). In the next step, the worker calculates the total postage balance by subtracting any postage already paid from the postage due (i.e., the amount due minus the amount paid) (step S76). This total postage balance is used in preparing a “Postage Due manifest,” which lists all of the packages that require additional postage fees, and summarizes, among other things, the total postage fees for each package due to the postal delivery company upon delivery S77). Workers may also generate another type of report, which is known as the “special service manifest,” listing all packages that require some type of authorization, such as in the form of a signature, of the special service from the recipient.

As further illustrated in FIG. 2, the final step in each vendor's production line involves simultaneously delivering the manifest(s) and the listed packages in accordance with each package's number (if any) and/or destination zip code (steps S58, S60, S62, S64). Typically, the postage due manifest contains the postage due for all packages to be returned to a particular vendor, as well as a listing of postage due for each package (if any) that has been assigned a package number. Delivery of the manifest(s) and the listed packages often occurs on a daily basis. Since delivery occurs daily, postal workers must perform the time consuming processing steps illustrated in FIG. 3 either during the night before delivery, or during the early hours of the day before packages can be delivered back to each vendor. Since the packages cannot be, delivered until after completion of the processing steps, the processing steps act as a bottleneck by limiting the throughput of the prior art return merchandise delivery system. As a result, postal delivery companies must expend greater resources in hiring workers at higher labor rates in order to perform these labor intensive return mail processing steps at inconvenient times.

### SUMMARY OF THE INVENTION

The advantages and purposes of the invention will be set forth in part in the following description, and in part will be obvious from the description, or may be learned by practice of the invention. It should be understood that the invention is not limited to the illustrative examples found in this specification. Rather, the invention is intended to cover all modifications and variations that come within the scope of the appended claims. Moreover, the advantages and purposes of the invention will be realized and attained by means of the elements and combinations particularly pointed out in each of the appended claims.

One embodiment of the present invention is directed to a system for processing return merchandise packages having a transport device for receiving a plurality of different types of return merchandise packages and transporting the packages along a processing path, and a weighing device in communication with a database network configured to weigh each of the packages, the weight of each package being stored in the database network. The system may also include an image lifting device in communication with the database network and located proximate to the processing path of the packages for creating at least one image of each of the packages to be stored in the database network, the package being transported along the processing path to a sorting location wherein the packages will be sorted by type. The system may further include a processing workstation in communication with the database network and configured to allow an operator to perform postage due calculations remote from the processing path based upon the package image and the weight information in the database network.

The present invention may also be directed to a computer-implemented system for return processing a plurality of articles each having a destination zip code and a type of service requested. This system may include having an article receiving station configured to receive a plurality of articles from senders for return processing and delivery in accordance with the destination zip code of each of the plurality of articles, and the type of service requested for each of the plurality of articles and a weighing station configured to weigh each of the plurality of articles and storing weight information in a database in communication with a network. The system may also include a scanning station configured to scan at least one image for each of the plurality of articles and storing the at least one image for each of the plurality of articles into a scanning database in communication with the network and a sorting station configured to direct each of the plurality of articles to one of a plurality of bins based on the destination zip code of each of the plurality of articles and the type of service requested for each of the plurality of articles. The system may further include a remote processing workstation in communication with the network so as to allow an operator to determine postage due calculations by processing the at least one image of each of the plurality of articles, and generate at least one report listing postage due for each of the plurality of articles and delivery service information for articles having a requested service.

Moreover, the present invention relates to a computer-implemented method for return processing a plurality of articles each having a destination zip code including the steps of receiving a plurality of articles from senders for return processing and delivery in accordance with the destination zip code of each of the plurality of articles, and weighing each of the plurality of articles and storing weight information in a database. The method may also include the steps of scanning at least one image for each of the plurality of articles, storing the at least one image for each of the plurality of articles into a database, and manually sorting each of the plurality of articles based on the destination zip code of each of the plurality of articles. The method may further include the step of video processing the at least one image for each of the plurality of articles at the remote workstation so as to generate at. least one report listing delivery service information for each of the plurality of articles.

In addition, the present invention covers a computer-implemented system for return processing a plurality of articles each having a destination code including an article receiving station for receiving a plurality of articles from senders for return processing and delivery in accordance with the destination code of each of the plurality of articles, and a weighing station for weighing each of the plurality of articles and storing weight information in a database in communication with a network. The system may also include a scanning station in communication with the network to scan at least one image for each of the plurality of articles and store the at least one image into the database in communication with the network, a processing module in communication with the network for processing information about each package stored in the database, and a display station in communication with the processing module to display a list of potentially correct sort locations based on information processed in the processing module. The system may further include a sorting station disposed adjacent to the display station to allow an operator to select one of the displayed list of potentially correct sort locations, and at least one storage station connected to the sorting station to receive each of the articles in accordance with the destination code of the article. In addition, the system may include a processing workstation in communication with the network and configured to allow an operator to perform a postage due calculation based upon the information in the database.

Similarly, another embodiment of the present invention may be directed to a computer-implemented method for return processing a plurality of articles each having a destination code comprising the steps of receiving a plurality of articles from senders for return processing and delivery in accordance with the destination code of each of the plurality of articles, weighing each of the plurality of articles, storing weight information in a database in communication with a network, and scanning at least one image for each of the plurality of articles. The method may also include the steps of storing the at least one image into the database in communication with the network, processing the information stored in the database to eliminate alternative sort locations and to display a list of potentially correct sort locations, selecting one of the displayed list of potentially correct sort locations, transporting the article in accordance with the selected one of the displayed list of potentially correct sort locations, and processing the information in the database at a location remote from the articles to perform postage due calculations.

Further, the present invention relates to a return merchandise package processing system include a weighing device configured to weigh a plurality of packages and store weight information for each of the plurality of packages in network database, a lifting device configured to lift an image of each of the plurality of packages, and an image recognition device configured to recognize delivery information based on the image of each of the plurality of packages. The system may also include a process controller configured to generate sort control signals and perform postage due calculations for each of the packages based on the delivery information recognized by the image recognition device, and a sorting device in communication with the process controller to direct each of the plurality of packages to one of a plurality of sort locations based on the sort control signals generated by the process controller.

Finally, the present invention is directed to a method of processing return merchandise packages comprising the steps of weighing a package, storing weight information of the package, lifting an image of the package, recognizing delivery information based on the image of the package, and generating sort control signals based on the delivery information recognized. The method may also include the steps of performing postage due calculations for the package based on the delivery information recognized, and directing the package to one of a plurality of sort locations based on the sort control signal generated.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

In the drawings,

FIG. 1 is a block diagram generally illustrating a conventional return processing system;

FIG. 2 is a block diagram more particularly illustrating a conventional return processing system;

FIG. 3 is a block diagram illustrating the conventional procedure for manually processing articles;

FIG. 4 is a general schematic of the video coding apparatus;

FIG. 5 is a block diagram illustrating a first embodiment of a system of the present invention;

FIG. 6 is bock diagram comparing the steps of the conventional handling system with an exemplary embodiment of the present invention;

FIG. 7 is a block diagram illustrating a second embodiment of a system of the present invention;

FIG. 8 is a block diagram illustrating a third embodiment of a system of the present invention;

FIG. 9(a) is a cross-sectional view illustrating a first embodiment of a scanning station of the present invention;

FIG. 9(b) is a cross-sectional view illustrating a second embodiment of a scanning station of the present invention;

FIG. 9(c) is a cross-sectional view illustrating a third embodiment of a scanning station of the present invention; and

FIG. 10 is a block diagram illustrating an alternative embodiment of the present invention.

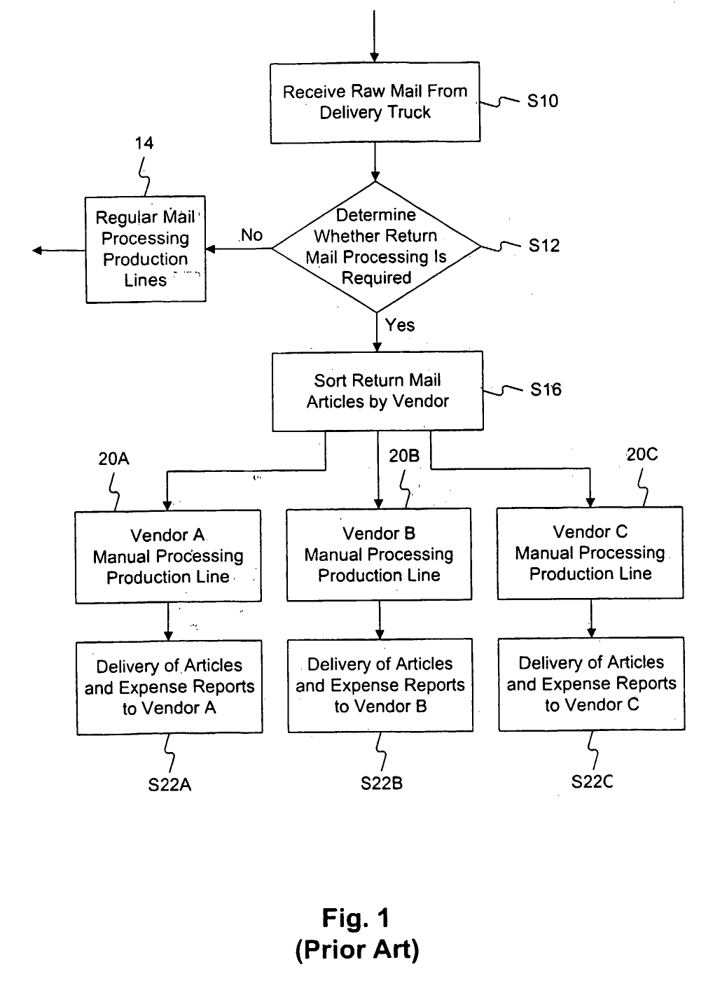

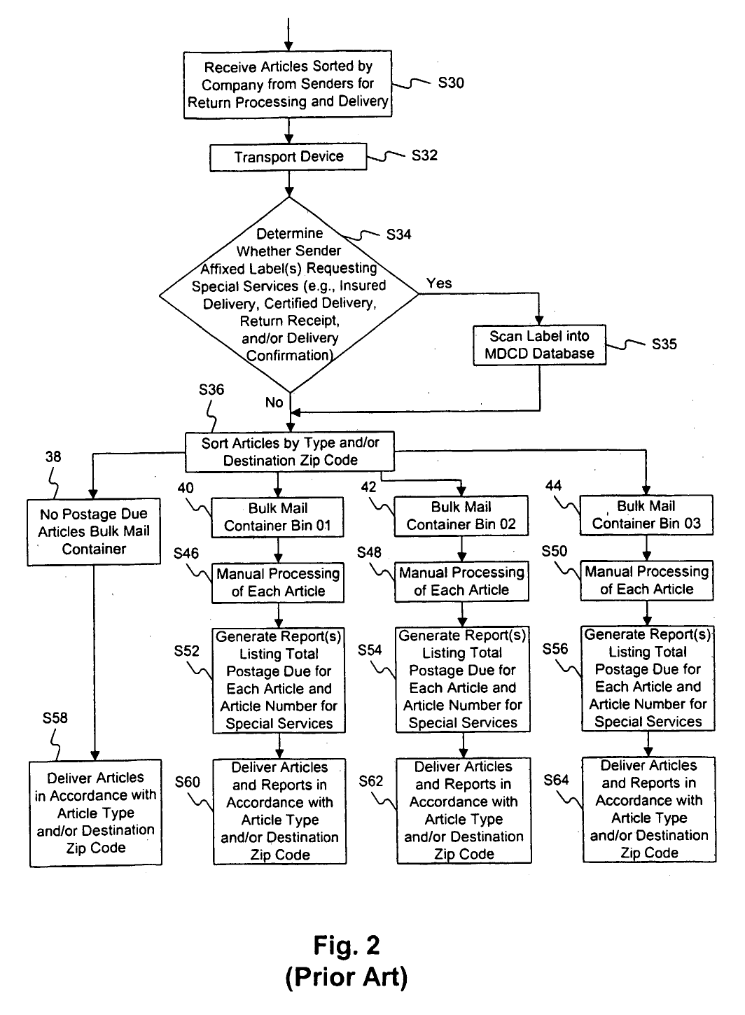

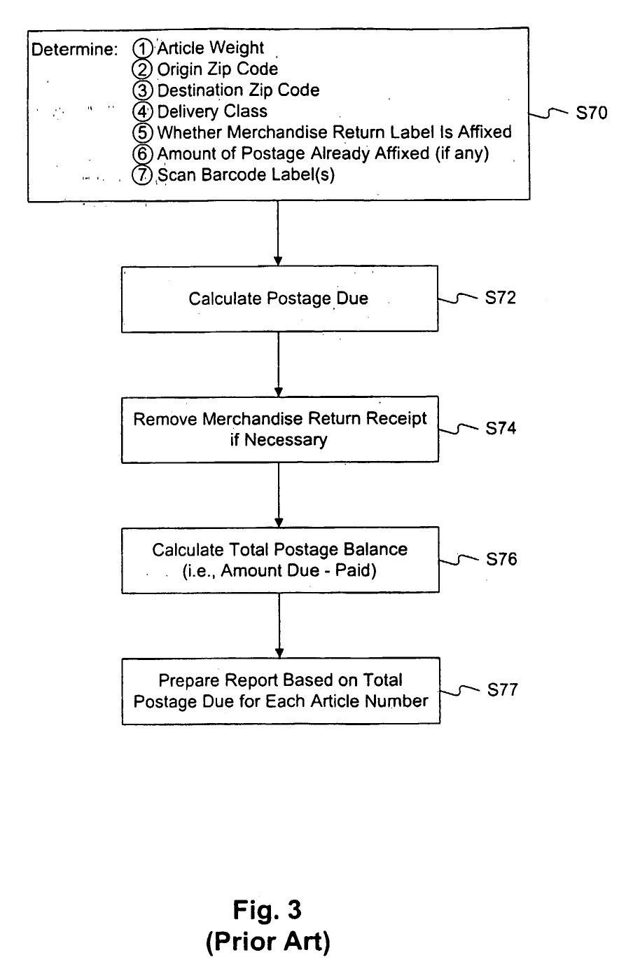

### DETAILED DESCRIPTION

Reference will now be made in detail to the present preferred embodiments of the invention illustrated in the accompanying drawings. Wherever possible, the same reference numbers are used throughout the drawings to refer to the same or like parts.

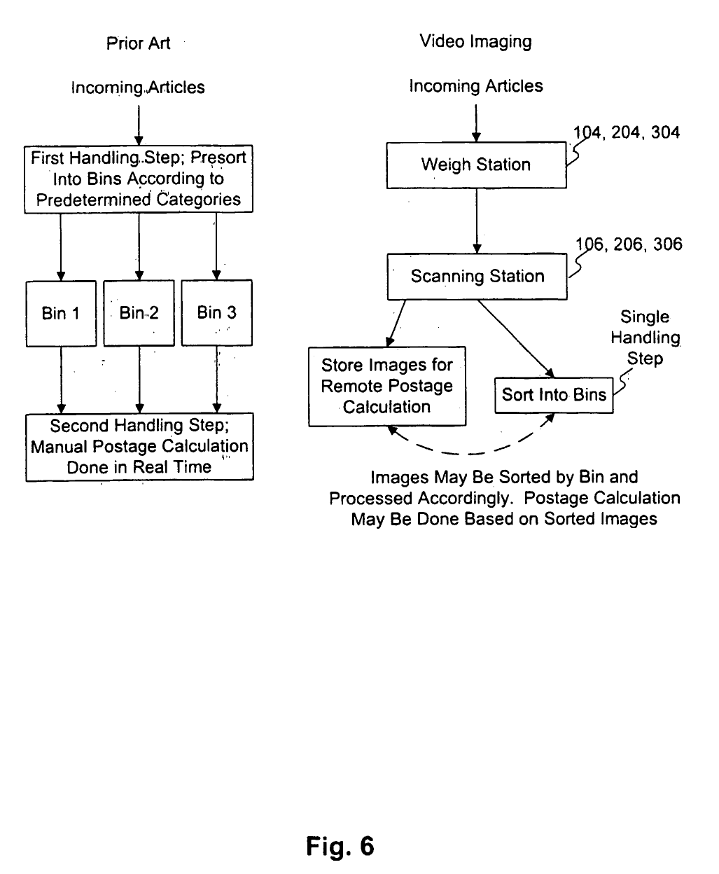

Generally, the present invention is intended to improve upon the prior art in one or more of the following ways. As illustrated in FIG. 6, the present invention provides a more streamlined process for the handling of returned merchandise. By providing fewer handling steps (i.e., the illustrated single handling step, rather than the prior art two handling steps), the present invention may result in more efficiently processing and delivering return mail packages. Moreover, the present invention may improve the throughput of processing and delivering return mail articles by separating out the postage calculation step from the step of handling the articles themselves. Separating the calculating steps from the article handling steps can result in improved throughput and efficiency in many ways, such as by reducing bottlenecks. The postage calculation steps can be performed by examining scanned images of the articles. Images can be sorted by bin and processed accordingly. On the other hand, a single handling step for each article can be accomplished without waiting for the postage calculations steps to be performed in real-time.

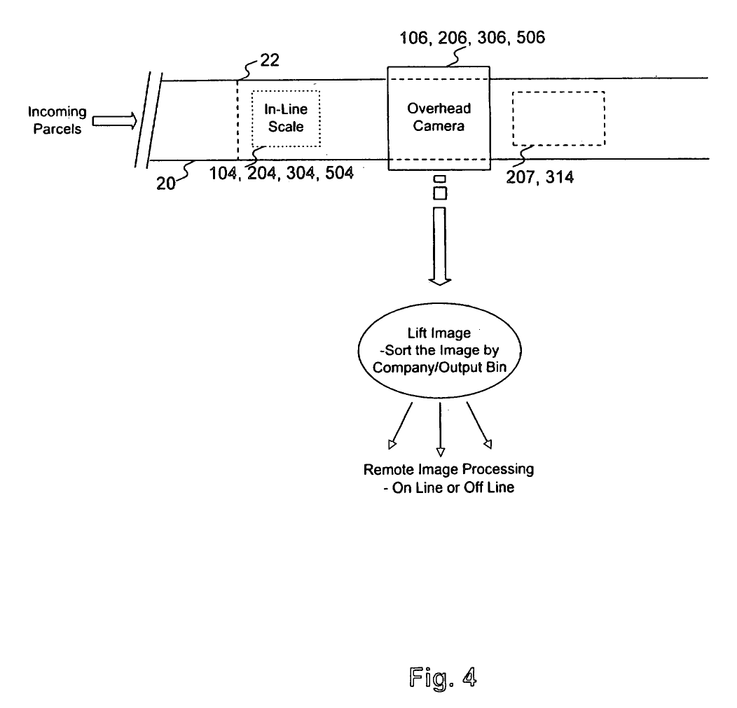

As shown in FIG. 4, a first embodiment of the present invention includes a transportation mechanism such as a conveyor belt, a weighing station, alternatively referred to as a “in-line” scale, a scanning station, and a keyer decision point station 207, 314. In operation, the conveyor belt receives incoming parcels and transfers them past the weighing station, the scanning station, and the keyer decision point station 207, 314. At the in-line scale, each of the parcels is weighed and the weight of each of the parcels is downloaded into a computer-implemented network database. Preferably, an in-line scale is used to weigh each parcel without having to remove it from the conveyor belt. At the scanning station, workers employ an overhead camera to “lift” one or more images of the parcels, and store the images into the computer-implemented database. The term “lift” is not limited to any particular type of operation, and is intended to refer to any known way of capturing an image of a surface of a parcel, such as by employing a camera or scanner to generate optical or electronic beams upon the surface to be lifted. Any commercially available camera may be used to capture an image of the surface of each parcel so long as the image captured is of sufficient resolution and sufficient size to accomplish information processing by either human observation or computer software recognition.

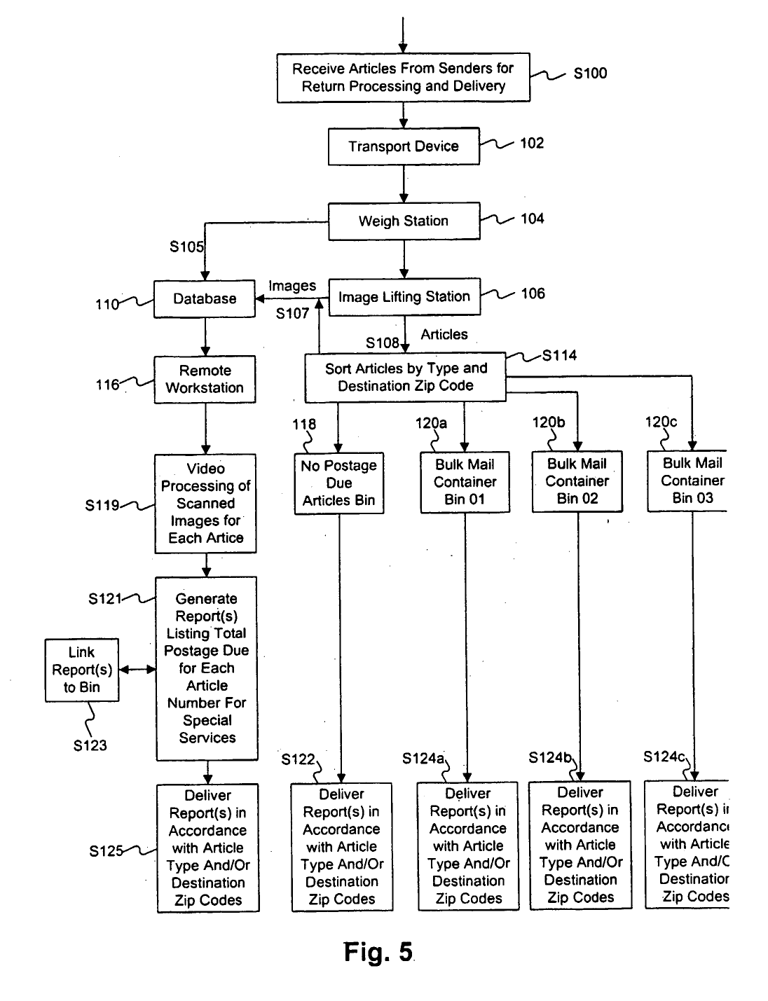

FIG. 5 is a more detailed block diagram illustrating the flow of articles through the first embodiment of the present invention illustrated in FIGS. 4 and 6. As shown in step S100, each return merchandise article is first received from a consumer, alternatively referred to as the “sender,” and then placed on a transport device 102, such as, for example, a conveyor belt. Prior to this step, each article can be presorted based on the particular vendor or address who sent the merchandise to the consumer. Optionally, the presort step may be omitted and each article may be placed on the transport device 102 in essentially raw form.

Transport device 102 first conveys each article through weigh station 104 and image lifting station 106. At weigh station 104, each article's weight is transmitted to a network database 110 (step S105). Similarly, an image of each article is created at image lifting station 106. This image is then also transmitted to network database 110 (step 107). Once the images are stored in the network database 110, postal workers may sort the images by company or output bin at one or more remote processing stations 116 connected to the network database 119. Preferably, they perform video processing of the scanned images for each article to sort the images in real time, at a convenient time or place, such as at the keyer station without regard to the location of the parcels themselves (step S119). Accordingly, postal employees can perform video processing tasks during periods of time where labor rates are lower and at locations where real estate costs are lower.

Processing stations 116 are not limited to any particular type of station, and may involve any known type of workstation having a processor, a display, and an input device, such as a keyboard. During video processing (step S119), employees examine the image of each parcel to perform a number of information processing observations. These observations are done in order to generate an expense report or manifest summarizing the total postage fees due for each parcel. For instance, postal workers determine whether a label requesting special delivery services has been attached to each parcel. The term “special delivery services” is not limited to any particular type of service, and may include services such as delivery confirmation, which involves providing delivery information on a website or other accessible database. Alternatively, delivery confirmation can be accomplished by notifying the person requesting return delivery that the parcel was successfully returned. This type of notification can be done electronically, such as via E-mail, or through mail delivery of a confirmation receipt. A vendor or consumer may also view an image of the package itself by accessing a delivery confirmation website, and entering in a unique code, such as either a barcode corresponding to the package label, or a special identified code. Special services may also include other types of services, such as insured delivery, certified delivery, or return receipt. Postal workers also observe the images to determine each parcel's origin zip code, destination zip code, and delivery class, as well as whether a merchandise return label has been affixed to each parcel. Additionally, they should recognize the amount of postage already affixed (if any) to each parcel in order to determine postage due at a convenient time, or location such as at a remote keyer station.

After performing the image processing observations, postal workers may input a number of postage fee observations into the computer-implemented network database 110. They preferably calculate postage due for each package based on the weight, the origin, and the destination of the package. In calculating the total postage fees due for each parcel, the workers may calculate the total postage balance by subtracting any postage already paid from the postage due (i.e., the amount due minus the amount paid). This balance may be inputted into computer-implemented database 110. Then, workers may use the total postage balance stored in the computer-implemented database 110 to prepare the expense report or manifest summarizing the total postage fees due to be paid by the vendor, alternatively referred to as “addressee,” upon delivery (step S121). Preferably, this expense report lists the total postage due for each article and each article number for special services (e.g., the number represented by a special service bar code label). Then, each expense report may be electronically linked to the bin corresponding to the location of each of the articles listed in the report, (step S123). That is, a separate report is prepared for each bulk mail container storing specific packages. Expense reports, as well as special service manifest reports, can be delivered along with each of the listed parcels directly to the vendor's address (step S125).

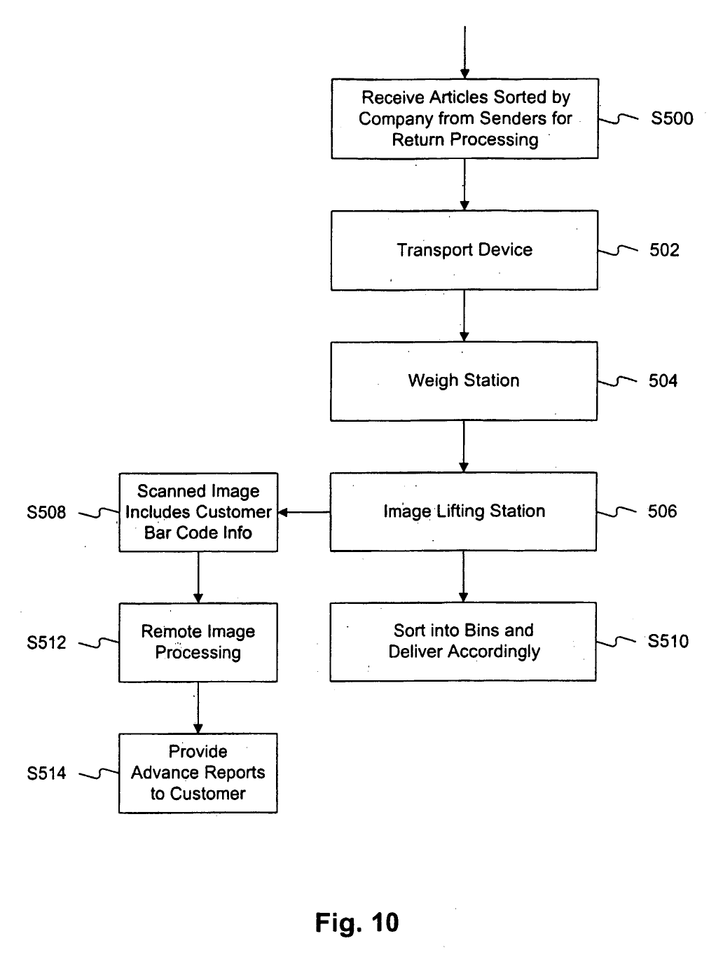

One embodiment of the invention involves delivering one or more expense report(s) before the listed parcels are actually delivered. As shown in FIG. 10, after receiving articles sorted by company from senders for return processing, (step S500), the transport device 502 conveys the articles past the weight station 504 and the scanning station 506. Upon arrival at the scanning station 506, each package may then scanned so that an image, which may include bar code information from a label affixed to the package, is created and downloaded to a remote processing station (step S508). Once images are received at the remote processing station, postal workers may then perform remote image processing (step S512) separately from the step of sorting packages into bins and delivering the packages accordingly. By separating the image processing step from the sorting step, this exemplary embodiment of the invention allows delivery of advanced expense report(s) to the customer, vendor, addressee, sender or any other interested party (step S514). Such advance notice can be beneficial to the receiving party in planning logistics for handling the returned merchandise.

A further aspect of the invention includes a central controller connected to the computer-implemented database 110 and in operative communication with the Internet. This central controller may act as a Web server hosting one or more Web sites and designed to permit electronic communications between a postal delivery company's interface, a vendor's interface, and/or a sender's interface, for example. Each Web site may be owned by or operated for, the benefit of a particular seller of goods or even a seller of delivery services. Web sites may also be provided that are owned by or operated for the benefit of a third party. There are many commercial software applications that can enable the communications required by the postal company interface and the vendor's interface. When the central controller is configured as a Web server, conventional communications software, such as, for example, the Netscape Navigator browser from Netscape or the Microsoft Internet Explorer from Microsoft Corporation, may also be used.

By way of illustration, a postal delivery company may use the Netscape Navigator browser, or another type of browser, to transmit or accept electronic delivery messages, such as in the form of postage expense reports or manifests, delivery updates at selected time intervals (e.g., at a prescribed time, every hour, every half hour, etc.), as well as parcel tracking information. As such, a postal delivery company can provide vendors with advance notice of when and how many parcels are expected to be return delivered in many ways. To provide such advance notice, the postal delivery company may facilitate access to the captured image of each package so that the vendor or the consumer can verify receipt and delivery information themselves. The service would provide an enhanced level of customer service. In practice, a vendor or a customer could access the image of a particular package by cross-referencing any unique data point, such as a special service barcode, a customer name, or the vendor's internal barcode, which was scanned or captured from the package itself.

By way of further example, the delivery company may also inform vendors of the total dollar amount of postage due for a selected number of parcels being returned on a given day. By providing this advance notice of the parcels being returned, the present invention may allow vendors to develop work force management plans in anticipation of receiving large amounts of parcels during a particular period of time. Postal workers may also transmit or receive electronic messages, such as in the form of internal tracking information, among themselves to coordinate the delivery process or assist in the video processing of each parcel's image. By the same token, vendors may employ a number of different types of communication protocols to receive electronic messages from the postal delivery company and transmit delivery requests directly to the postal delivery company. Vendors may further link their own browsers or electronic communication protocols to their own databases. They may then provide delivery companies with personal account information so that each vendor's account can be electronically debited or credited accordingly. Similarly, consumers may also utilize various types of Internet communication protocols to access delivery information or receive electronic messages concerning the status of deliveries, the outstanding balance due, the viewing of images of packages themselves, or any other helpful information. To utilize this aspect of the invention, not only the postal delivery company, but also vendors and consumers may be required to use proprietary software to generate or receive electronic messages or commands.

After passing through image lifting station 106, the parcels then reach a sort station, alternatively referred to as a “key decision point station,” where workers sort the parcels and input sort information into a display and input screen connected to the network database (step S108). The input and display panel preferably includes a touch screen panel for displaying options and allowing postal workers to enter sort information for each parcel. One skilled in the art will appreciate that any type of software is suitable for displaying sort options and other information. For example, a series of graphical user interfaces, which can be either window based or menu driven, for example, may be used to assist postal workers in making sort decisions and inputting appropriate sort information for each parcel, such as each parcel's type, destination zip code, and/or downstream destination bin. Moreover, the input and display panel may involve two display screens; a first screen for displaying video images of each article, and a second screen for allowing a postal worker to enter sort information. Incidently, by allowing a worker to observe the video image while entering sort information, the worker may also identify whether each article's image is of sufficient quality to permit video processing at the remote workstations. If a particular image is not of sufficient quality, then the worker may re-route the package to a default sort location where the article can be reexamined in more detail and re-scanned to generate a better image.

In sorting parcels, the workers may identify sufficient information to designate the bulk mail container bin to which the package is to be directed. The type of information necessary to make this determination is dependent upon the specific process being implemented. It may include, for example, one or more of the following: a destination code (such as a zip code); the physical characteristics of the package (e.g., letter or box or irregular shape); or the type of service being requested (e.g., insured). This information is inputted via a touch screen panel, which transmits such information to the network database 110. Finally, each parcel is directed to one of a plurality of bins 118, 120a, 120b, 120c. Optionally, each container bin may have a particular bin number registered within the computer-implemented database 110. Each parcel may then be electronically linked, alternatively referred to as “married,” to each particular bin number based on each parcel's type and destination zip code.

Since each of the bins correspond to a particular parcel's type and/or destination zip code, workers may simply determine the correct bin destination (e.g., bin 118, bin 120a, bin 120b, or bin 120c) for each parcel based on each parcel's type and/or destination zip code. For instance, if an article does not involve any postage due (i.e., a straight type of article), then that article is sent to the “No Postage Due Articles Bin” 118. Alternatively, if an article is to be delivered to the 01 destination zip code, then workers send that article to the “Bulk Container Bin” 01. When a desired number of articles are placed in the correct bin, they may then be immediately delivered in accordance with each article's type and/or destination zip code, (steps S122, S124a, S124b, or S124c). As a result, postal workers may deliver the articles without waiting for expense report(s) to be prepared.

Another aspect of the invention includes a network processor, which links the weight information received from weigh station 104 with the image data information created in the image lifting station 106, and the sort decision information inputted at sorting station 114. Once this information is linked to each parcel, remote image processing can be simplified. For example, by utilizing the decision made at sorting station 114 (i.e., identifying each parcel's type, the destination zip code, and/or the registered bin number), the images of each of the articles can also be sorted to correspond to the sorting of the physical parcels themselves. Image sorting improves the efficiency of performing the information processing steps discussed above by simplifying the processing steps themselves. By way of illustration, postal employees may target particular sets of parcel images for processing, rather than processing random parcel images each having either different types or different destination zip codes. Targeting of specific sets of parcel images may allow postal workers to reduce the number of keystrokes required to process the images and decreases the number of decisions that must be made to process the targeted set of images. Moreover, postal employees may target images generated during selected periods of time and, generate expense reports for particular vendors without having to view each parcel image. By freeing workers from having to “key-in” (e.g., make a keystroke) the type and/or destination zip code for each image, workers may then improve productivity by spending less time processing each image. For instance, a postal employee may choose to view images of Vendor A's parcels received within the last business day and generate corresponding expense report(s) for delivery to Vendor A, without having to view images of Vendor B.

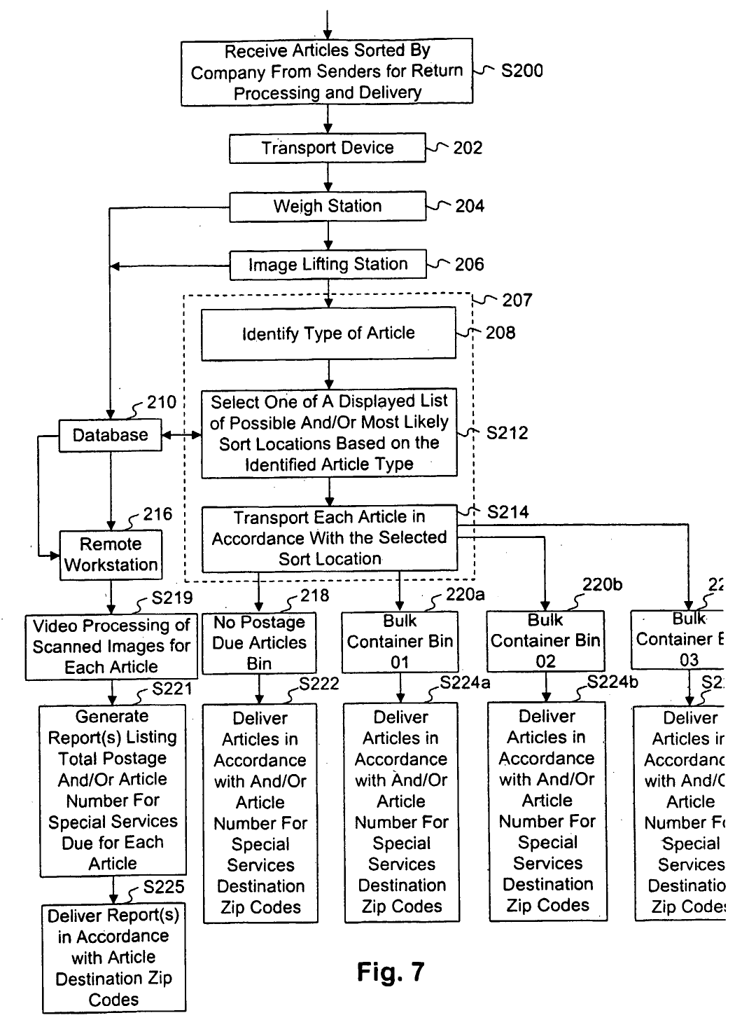

FIG. 7 is an image processing flow diagram of a second embodiment of the present invention. Many of the processing steps are the same as in the earlier described embodiment. Transport device 202 receives return merchandise articles, which may already have been sorted by company, (step S200), and then conveys each article through weight station 204, the scanning station 206, and the sorting station 207. As in the previous embodiments, the image and the weight of each article are transmitted to the network database 210. However, this embodiment of the invention may utilize a central controller run by optical character recognition (“OCR”) technology to examine each of the article images received from scanning station 204 and assist the worker at sorting station 207 in inputting sort decisions into an input and display panel. One skilled in the art of OCR technology would know that many different types of software or hardware could be used to recognize information contained in images of different types of articles. Any type of software technology may be used so long as the central controller can display a list of possible and/or most likely sort locations at the input and display panel (step S212). To do so, the central controller uses the inputted article type information stored in database 210 to determine which sort locations are not possible and, then, prevent the workers from being able to select any of the unlikely sort locations. In some embodiments, a worker may input selected information about the parcel being processed (step 208) to supplement the OCR technology in (1) eliminating certain sort locations and (2) displaying a subset of potentially correct sort locations. One skilled in the art will appreciate that the central controller may eliminate unlikely sort locations by any known means, such as by graying out unlikely selections on the touch screen of the input and display panel so that a worker can choose from only a displayed list of probable sort locations. Upon viewing this list, postal employees may select one of the list of possible sort locations by pressing an icon on the touch screen of the input and display panel (step S212). After making this sort decision, each article may be transported accordingly (step S214).

As in the previously described embodiments, remote workstation 216 provides a convenient and efficient way for postal employees to video process each package image (step S219) and generate reports listing the total postage and/or article number for special services due for each article (step S221), since the employees at sorting stations 207 have already inputted the sort location (e.g., one of a list of bulk container bins 218, 220a, 220b, 220c) for each article. Moreover, creating an image of each package allows postal workers to perform the image processing steps independently from the package sorting and handling steps. This separation of workloads enables postal companies to deliver expense reports in accordance with each of the listed package's destination zip codes, (step S225), regardless of when or how the packages themselves are delivered (steps S222, S224a, S224b, S224c). As a result of this separation, bottlenecks caused by the processing steps may not slow down the throughput of the packages through the system.

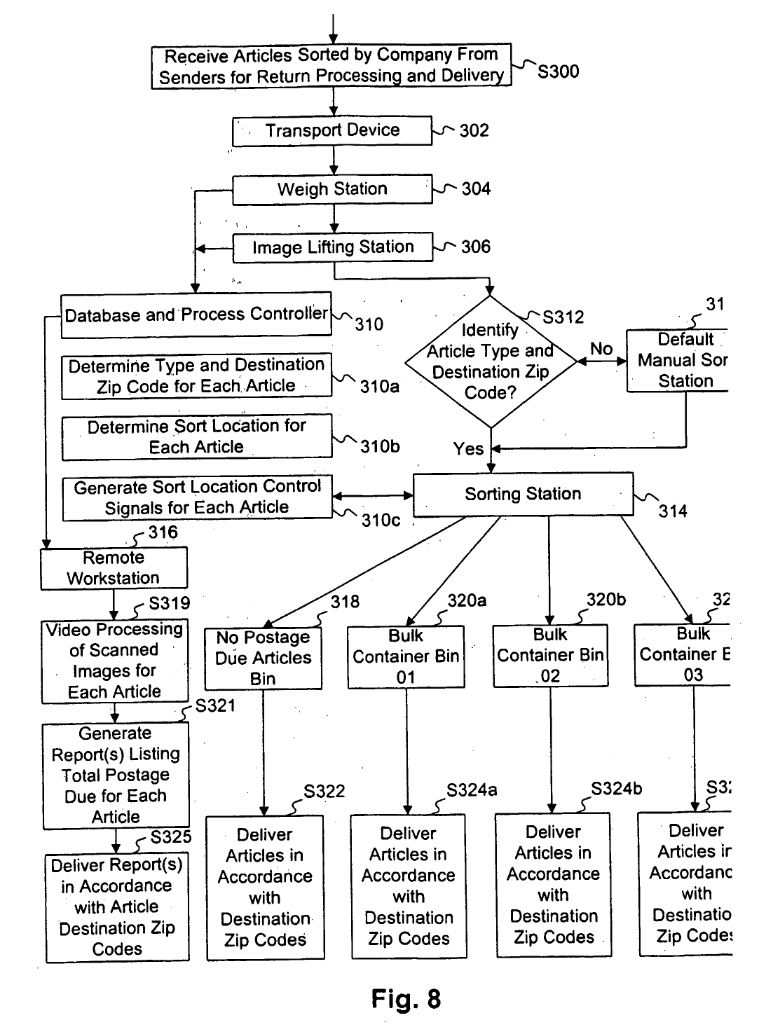

FIG. 8 is a flow diagram of a third embodiment of the present invention that involves both automated video processing of the image and automated sorting of the packages themselves. As in the previously described embodiments, a transport device 302 receives articles, each of which can be presorted by vendor, from senders for return processing and delivery (step S300) and transports each article through weight station 204, scanning station 206 and sorting station 314. An exemplary aspect of this embodiment involves a database and process controller 310 in communication with sorting station 314. In operation, controller 310, which may employ the OCR software discussed in the previous embodiment, automatically analyzes each parcel's image. Any other type of software may be used so long as the necessary information for each article can be determined. In this particular embodiment, the software may determine the article's type and destination zip code. In analyzing these images, the controller first recognizes each article's type and destination zip code (step S310a), and then determines the sort location for each article (step S310b). Once controller 310 has done so, it then generates sort location control signals for each article and transmits these signals directly to sorting station 314.

Upon arriving at sorting station 314, articles may be then directed to one of a plurality of bin locations by a sorter, which receives the sort location control signals from controller 310. Any type of sorting device may be used to send parcels to specific locations. The sorting device may involve any combination of automatic control systems and associated mechanical or electro-mechanical parcel handling devices. Alternatively, it may consist of a screen that displays sort locations for each article to a worker at sorting station 314. After viewing this display, workers may send, either manually or by pressing one or more control icons, articles to respective bins. For instance, parcels that require no additional postage to be paid are automatically sent to the “No Postage Due Articles Bin” 318. Other parcels, such as those having destination zips codes of 01, 02, 03, as illustrated, are automatically sent to one of several bulk container bins 320a, 320b, 320c.

Another aspect of this embodiment includes a default manual sort station 313, which receives articles that cannot be identified. For example, if the controller 310 cannot identify an article's type and/or destination zip code (step S312), then that article may then be routed to default sort station 313, where a worker may examine the article to input type and destination zip code information into the database and process controller 310. Articles can then be either rerouted back to scanning station 306 or re-scanned at default station 313 itself in order to generate adequate images of the articles for video processing. In either event, once each article's type and/or destination zip code is sufficiently identified, they are sent to sorting station 314.

Yet another aspect of the invention may include a sorting station having a display screen for allowing workers to observe whether the database and process controller 310 has correctly recognized the type and/or destination zip code of each article. Since the database and process controller 310 contains and catalogs article images, workers may perform a statistical analysis of the controller's effectiveness. This statistical analysis, in turn, can be used to improve the OCR technology itself. Optionally, the database and process controller 310 may generate an advance warning signal to the postal workers notifying them of potential problems with either the control system itself or the quality level of a particular article's image. Postal employees can then use this warning signal to take appropriate action to avoid bottlenecks in sorting station 314, such as by directing one or more articles to default manual sort station 313.

An additional aspect of this embodiment of the invention includes the use of OCR technology to allow database and process controller 310 to automate the information processing steps. Such an automatic system may perform the information observation and processing steps of the previously described embodiments without any assistance from postal employees. One skilled in the art would know that many different types of software and hardware could be employed to perform image processing observations by identifying and distinguishing between different types of information contained within an image of a package. In operation, OCR technology may be used to automatically recognize whether a label requesting special delivery services has been attached to each package. By the same token, the OCR technology may automatically examine each image to recognize other types of information, such as each package's origin zip code, destination zip code, and delivery class. Moreover, the OCR technology may automatically determine the presence or absence of a merchandise return label, as well as the amount of postage already affixed (if any) to each parcel.

After performing the information observation steps, the system then automatically inputs a number of postage fee observations into database and process controller 310. Process controller 310 then calculates the total postage due for each article based on the weight, the origin, and the destination of the package. A skilled artisan in the art would readily know of various types of processors that can be used to perform these calculations. To calculate the total postage fee for each article, the process controller 310 may subtract any postage already paid from the postage due (i.e., the amount due minus the amount paid). Once the total postage fee for each article is determined, the process controller 310 may then automatically generate an expense report or manifest based on various parameters selected by a system operator (step S321). The system operator may also modify the operation of the process controller 310 in order to generate different types of expense reports. As in the previously described embodiments, the postage due and special services reports may summarize the total postage fees due to be paid by an addressee upon delivery, and the special services that require authorization. Preferably, this expense report may list the total postage due for each article and each article number for special services (e.g., the number represented by a special service bar code label). Alternatively, the special services expense report may be electronically linked to the bin corresponding to the location of each of the articles listed in the report. The process controller 310 may then print out expense reports at a location selected by the system operator. For instance, if the expense reports are to be delivered along with each of the listed parcels, the system operator can then select a print site adjacent to a BMC containing the listed parcels. Once received at this print site, a postal worker may then affix the report to the BMC before shipping the BMC to the addressee. On the other hand, the system operator may instruct process controller 310 to automatically send the expense reports directly to the addressee, such as via the Internet as discussed in the previous embodiments.

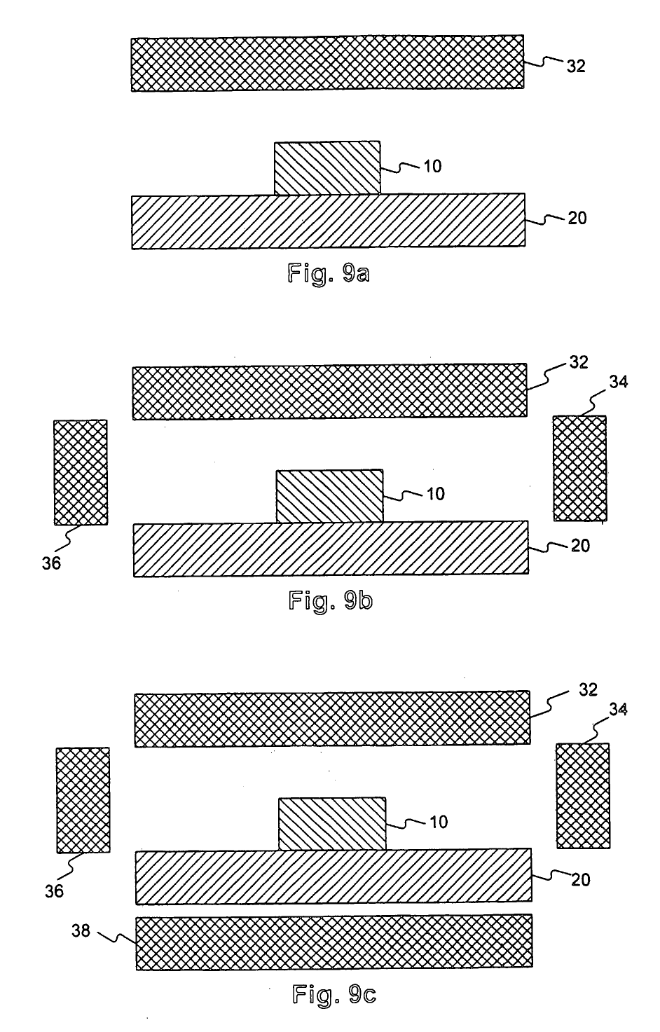

FIGS. 9a-c illustrate three different embodiments of the scanning stations 106, 206, 306. The first embodiment (i.e., FIG. 9a) includes a conveyor 20 that transfers articles 10 under an overhead scanning surface 32. This surface 32 can either be a planar or a curvilinear shape so long as light or some other medium can be directed onto a surface of the article 10. Optionally, the scanning surface 32 could be shaped to receive one, two, or three dimensional images of each article 10. Since the overhead scanning surface 32 faces a top side of each article 10, workers must orient each article so that the top side facing the scanning surface 32 features the necessary information.

The second embodiment (i.e., FIG. 9b), on the other hand, includes three image scanning surfaces 32, 34, 36 facing three sides of each article 10. Because these scanning surfaces 32, 34, 36 do not face the bottom side of each article 10, workers must orient each article 10 to insure that the side containing video processing information is not facing the conveyor 20 during the scanning step.

In the third exemplary embodiment (i.e., FIG. 9c), four scanning surfaces 32, 34, 36, 38 may be used to generate images of all four sides of each package 10. In this embodiment, the conveyor 20 may be made of one or more portions of transparent material, which allows a image scanning surface 38 to generate an image of the bottom side of each article 10. Alternatively, the conveyor 22 may have a lateral slot 22, as illustrated in FIG. 4, which allows a line-scan camera 30 to generate a plurality of sliced images of a surface of the package 10, and thereby construct a full image of the surface of package 10. One skilled in the art will appreciate that many other variations are envisioned, all of which fit within the scope of the present invention. For instance, a wide range of shapes, numbers, material, and sizes of discrete image scanning surfaces can be used to scan images of irregularly shaped parcels. In another embodiment, two additional scanning surfaces (not shown) may be placed at the front and rear of the package 10 so that an image of each of the six sides of each package 10 may be generated.

Other embodiments of the invention will be apparent to those skilled in the art from consideration of the specification and practice of the invention disclosed herein. It is intended that the specification and examples be considered as exemplary only. Thus, it should be understood that the invention is not limited to the illustrative examples in this specification. Rather, the invention is intended to cover all modifications and variations that come within the scope of the following claims and their equivalents.

What is claimed is:

1. A system for processing return merchandise packages, comprising:
a transport device having a processing path, the transport device disposed to receive a plurality of different types of return merchandise packages and transport the packages along the processing path;
a database network;
a weighing device in communication with the database network configured to weigh each of the packages, the weight of each package being stored in the database network;
a sorting location where the packages will be sorted by type;
an image lifting device in communication with the database network and located in or adjacent to the processing path of the packages for creating at least one image of each of the packages to be stored in the database network, the packages being transported along the processing path to the sorting location; and
a processing workstation in communication with the database network and configured to allow an operator to perform postage due calculations remote from the processing path based upon the package image and the weight information in the database network.

2. The system of claim 1, wherein the processing workstation is configured to allow an operator to generate at least one report listing at least one of a postage due and special delivery service information for at least one of the plurality of different types of packages.

3. The system of claim 1, wherein the different types of return merchandise packages include packages to be returned to different destinations.

4. The system of claim 1, wherein the image scanning device includes at least one scanning surface facing a surface of the package.

5. The system of claim 1, wherein the different types of return merchandise packages include different configurations of packages, at least some of which are to be returned to the same destination.

6. A computer-implemented system for return processing a plurality of articles having a destination zip code and a type of service requested comprising:
an article receiving station configured to receive a plurality of articles from senders for return processing and delivery in accordance with the destination zip code of the plurality of articles and the type of service requested for the plurality of articles;
a network and a database in communication with the network;
a weighing station configured to weigh each of the plurality of articles and store weight information in the database;
a scanning database in communication with the network;
a scanning station configured to scan at least one image for each of the plurality of articles and store the at least one image for each of the plurality of articles into the scanning database;
a plurality of bins for receiving sorted articles;
a sorting station configured to allow for manual directing the plurality of articles to one of the plurality of bins based on the destination zip code of the plurality of articles and the type of service requested for the plurality of articles; and
a remote processing workstation in communication with the network so as to allow an operator to determine postage due calculations by processing the at least one image of each of the plurality of articles and to generate at least one report listing at least one of a postage due and special delivery service information for each of the plurality of articles and delivery service information for articles having a requested service.

7. The system of claim 6, further comprising a scanning device configured to scan the type of service requested from the articles before the articles reach the scanning station.

8. The system of claim 6, further comprising a process controller to sort the images into predetermined groups corresponding to the plurality of bins before an operator performs postage due calculations.

9. The system of claim 6, wherein the type of service requested for any one of the plurality of articles includes at least one of an insured delivery service, a certified delivery service, a return receipt service, or a delivery confirmation service.

10. The system of claim 6, wherein the remote processing workstation is configured to electronically link a report to one of the plurality of bins based on a location of each of the articles listed in the report.

11. A computer-implemented method for return processing a plurality of articles each having a destination code comprising the steps of:
receiving a plurality of articles from senders for return processing and delivery in accordance with the destination code of each of the plurality of articles;
weighing each of the plurality of articles and storing weight information in a database;
scanning at least one image for each of the plurality of articles;
storing the at least one image for each of the plurality of articles into a database;
manually sorting each of the plurality of articles based on the destination code of each of the plurality of articles; and
video processing the at least one image for each of the plurality of articles at the remote workstation so as to generate at least one report listing delivery service information for the plurality of articles.

12. The method of claim 11, further comprising the steps of:
receiving a request for a specific type of service from at least one of the articles; and
storing the request for a specific type of service into the database.

13. The method of claim 11, wherein the step of receiving a request for a specific type of service includes the substep of scanning at least one label provided on the at least one of the articles.

14. The method of claim 11, wherein the delivery service information listed on the report includes a postage due statement for each of the articles.

15. The method of claim 12, wherein the step of manually sorting each of the plurality of articles includes the substep of transporting each of the plurality of articles to one of a plurality of bins containing articles having substantially similar destination codes and substantially similar types of requested services, and the step of video processing including the substep of sorting images of the articles corresponding to the bins containing the articles.

16. The method of claim 11, wherein the step of video processing occurs at a later point in time from the step of manually sorting.

17. The method of claim 11, further comprising the steps of delivering to a vendor the report listing service information for an article and delivering the article in accordance with the service information listed on the report.

18. The method of claim 17, wherein the report is delivered to the vendor before the articles identified in the report.

19. A computer-implemented system for return processing a plurality of articles each having a destination code comprising:
an article receiving station for receiving a plurality of articles from senders for return processing and delivery in accordance with the destination code of each of the plurality of articles;
a network and a database in communication with the network;
a weighing station for weighing each of the plurality of articles and storing weight information in the database;
a scanning station in communication with the network to scan at least one image for each of the plurality of articles and store the at least one image into the database in communication with the network;
a processing module in communication with the network for processing information about each package stored in the database;
a display station in communication with the processing module to display a list of potentially correct sort locations based on information processed in the processing module;
a sorting station disposed adjacent to the display station to allow an operator to select one of the displayed list of potentially correct sort locations;
at least one storage station in communication with the sorting station to receive each of the articles in accordance with the destination code of the article; and
a processing workstation in communication with the network and configured to allow an operator to perform a postage due calculation based upon the information in the database.

20. The system of claim 19, wherein the processing workstation is remote from the sorting station.

21. The system of claim 19, wherein the display station displays all potential sort locations and differentiates the potentially correct sort locations by displaying potentially correct sort locations in a uniform color.

22. The system of claim 19, wherein the display station displays only the potentially correct sort locations.

23. The system of claim 22, wherein the processing workstation sorts the images by destination codes.

24. The system of claim 19, wherein the sorting station includes a plurality of conveyor mechanisms, each of the conveyor mechanisms being in communication with a storage bin.

25. An computer-implemented method for return processing a plurality of articles each having a destination code comprising the steps of:
receiving a plurality of articles from senders for return processing and delivery in accordance with the destination code of each of the plurality of articles;
weighing each of the plurality of articles and storing weight information in a database in communication with a network;
scanning at least one image for each of the plurality of articles and storing the at least one image into the database in communication with the network;
processing the information stored in the database to eliminate alternative sort locations and to display a list of potentially correct sort locations;
selecting one of the displayed list of potentially correct sort locations;
transporting the article in accordance with the selected one of the displayed list of potentially correct sort locations; and
processing the information in the database at a location remote from the articles to perform postage due calculations.

26. The method of claim 25, wherein the step of processing the information stored in the database to eliminate alternative sort locations includes the substeps of:
recognizing a type and destination code of an article; and
determining a list of potentially correct sort locations based on the recognized type and destination code of the article.

27. The method of claim 25, wherein the step of transporting the article in accordance with the selected one of the displayed list of potentially correct sort locations includes a substep of directing the article to one of a plurality of storage locations.

28. The method of claim 25, further comprising the step of generating a report listing a postage due calculation for an article.

29. The method of claim 28, further comprising the step of linking the expense report to one of a plurality of bins based on a location of each of the articles listed in the expense report.

30. The method of claim 28, further comprising the step of delivering the article in accordance with a destination code associated with the article.

31. The method of claim 30, further comprising the step of delivering the report before the step of delivering the article.

32. The method of claim 25, further comprising the steps of:
receiving a request for a specific type of service from at least one of the articles; and
storing the request for a specific type of service into the database.

33. A return merchandise package processing system comprising:
a network database;
a weighing device configured to weigh a plurality of packages and store weight information for each of the plurality of packages in the network database;
a lifting device configured to lift an image of each of the plurality of packages;
an image recognition device configured to recognize delivery information based on the image of each of the plurality of packages;
a process controller configured to generate sort control signals and perform postage due calculations for each of the packages based on the delivery information recognized by the image recognition device;
a plurality of sort locations; and
a sorting device in communication with the process controller to direct each of the plurality of packages to one of the plurality of sort locations based on the sort control signals generated by the process controller.

34. The system of claim 33, wherein the image recognition device is configured to determine a destination code for each package and the process controller is configured to determine a sort location based on the destination code determined by the image recognition device.

35. The system of claim 33, wherein the image recognition device is configured to determine a type of special services requested for each package.

36. The system of claim 33, wherein the image recognition device is configured to identify whether delivery information can be recognized from an image of a package.

37. The system of claim 36, further comprising a default sort station to which a package will be directed after the image recognition device determines that delivery information cannot be recognized from that package.

38. The system of claim 35, wherein the process controller is configured to calculate postage due for each package by subtracting any postage already paid from the postage due for each package.

39. The system of claim 33, wherein the process controller is configured to generate at least one expense report based on the postage due calculation.

40. A method of processing return merchandise packages comprising the steps of:
weighing a package;
storing weight information about the package;
lifting an image of the package;
recognizing delivery information based on the image of the package;
generating sort control signals based on the delivery information recognized;
performing postage due calculations for the package based on the delivery information recognized; and
directing the package to one of a plurality of sort locations based on the sort control signal generated.

41. The method of claim 40, wherein the step of recognizing includes the substep of determining a destination code for the package.

42. The method of claim 40, wherein the step of recognizing includes the substep of determining a type of special services request for the package.

43. The method of claim 41, wherein the step of generating includes the substep of determining a sort location for the package based on the destination code for the package.

44. The method of claim 40, further comprising the step of identifying whether sufficient delivery information can be recognized from an image of a package to facilitate delivery.

45. The method of claim 44, wherein the step of identifying includes the substep of determining that the image of the package does not allow sufficient delivery information to be recognized, and further comprising the step of re-identifying delivery information of the package after the substep of determining that the image of the package does not allow sufficient delivery information to be recognized.

46. The method of claim 45, wherein the step of re-identifying delivery information includes manually examining the package and inputting delivery information for the package into the process controller.
